(19) United States
(12) Patent Application Publication
(10) Pub. No.: US 2008/0275700 A1
(43) Pub. Date: Nov. 6, 2008

(54) Method of and System for Modifying Messages

(75) Inventors: Peter Bingley, Mierlo (NL); Maarten Peter Bodlaender, Eindhoven (NL); Nicolaas Willem Schellingerhout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,179

(22) PCT Filed: May 17, 2005
(86) PCT No.: PCT/IB05/51596

§ 371 Date: Nov. 16, 2006

(30) Foreign Application Priority Data
May 27, 2004 (EP) 04102366.4

(51) Int. Cl. G10L 15/26

(52) U.S. Cl. 704/235; 704/E15.043

(57) ABSTRACT

The invention describes a method of and a system for modifying an input message (IM) containing audio content, which method comprises the steps of converting the audio content (A) of the input message (IM) into elements of a text representation (TR), segmenting the audio content (A) of the input message (IM) into constituent phonetic elements (Aₛ), correlating to the text representation (TR), rendering the text representation (TR) in a form suitable for editing the text representation (TR) in accordance with editing input, and altering the correlating phonetic elements (Aₛ) of the audio content (A) in accordance with the edited text representation (TR′) so as to give a modified audio content (A′) of an output message (OM).

### FIELD OF THE INVENTION

The invention relates to a method of and a system for modifying messages comprising audio and, optionally, video content, and to a messaging system.

### BACKGROUND OF THE INVENTION

Since the development of online user groups and chat rooms a few decades ago, messaging systems, which enable users to communicate by exchanging messages, have been enjoying a continual growth in user acceptance, particularly with the rapid expansion of the World Wide Web and the Internet. Other messaging systems enable users to send messages by means of, for instance, mobile telephones.

The early messaging scenario, involving a user typing his message by means of a keyboard, and the message subsequently appearing in written form on the destination user's PC, is quickly becoming out-dated as messaging systems use the increased bandwidth available to send video as well as audio message content.

One advantage of typed messages is that the typed text can easily be edited or modified in a matter of seconds, using a suitable editor until the message is satisfactory to the user, whereas audio and video, usually encoded in some digital form, are by no means easy for a user to modify. However, after recording an audio or video message, the audio might contain words with an undesirable intonation or unintended meaning, or the video might contain elements that the user does not wish to send after all. Since the effort involved in editing the audio and video is prohibitively high, an audio or video message containing even one small undesirable element must either be sent as it is or discarded in its entirety, compelling the user to re-record the message. Both audio and video processing are complicated and require high levels of dedication on the part of the average user in order for him to understand even the basics, while professional editing and mixing quality are unattainable for the vast majority of users.

### OBJECT AND SUMMARY OF THE INVENTION

It is therefore an object of the invention to provide a way of easily and intuitively modifying a message containing audio content before finally presenting it to a recipient.

To this end, the invention provides a method, which comprises the following steps:

converting the audio content of the message into elements of a text representation,
segmenting the audio content of the message into constituent phonetic elements correlating to the text representation,
rendering the text representation into a form suitable for editing,
modifying the text representation in accordance with editing input, and
altering the correlating phonetic elements of the audio content in accordance with the edited text representation so as to give a modified audio content of an output message.

An appropriate system for modifying an input message comprises an audio input for recording audio content of the input message, an audio-to-text converter for converting the audio content of the input message into elements of a text representation, an audio segmenting unit for segmenting the audio content of the input message into constituent phonetic elements correlating to the text representation, a rendering unit for rendering the text representation into a form suitable for editing, an editor for allowing editing of the text representation, and an audio alteration unit for altering the correlating phonetic elements in accordance with the edited text representation so as to give a modified audio content of an output message.

Thus, the invention provides an easy way for a user to generate an audio message and to introduce any necessary changes to this audio message before it is presented to the recipient, without the user having to be proficient in audio-processing techniques. The user can make any number of changes in the original message until he is satisfied that the message is correct and suitable for presentation.

The dependent claims and the subsequent description disclose particularly advantageous embodiments and features of the invention.

An audio input message may be recorded or captured by using a suitable recording device into which the user speaks, e.g. a microphone, connected to the converter in which an automatic speech recognition unit identifies the audio content of the input message and converts this into a digital text representation. The elements of the text representation may be given values marking elapsed time in chronological order, for example, by using a counter or a kind of clock, thus uniquely identifying the relative positions of the text representation elements in the audio content.

The constituent phonetic elements of the audio content may be entire words, groups of words, and fragments of a sentence, syllables, or even phonemes. An audio segmentation unit reduces the audio content to its constituent phonetic elements, for example, by applying suitable algorithms and/or filters.

A correlation or equivalence can easily be established between the text representation elements and the phonetic elements of the audio content by also assigning values to mark elapsed time in chronological order to the individual phonetic elements during the segmentation process. In this way, a phonetic element and its corresponding text representation element can be located or identified on the basis of their matching or corresponding time values. The time values may be some kind of marker or indication inserted directly into the text representation or into the audio content, or may be collected in a list with references to the appropriate point in the text representation or audio content.

To enable the user to check whether the audio content is satisfactory, it is presented to the user in a form suitable for editing. To this end, the text representation of the audio content may be rendered back into sound by means of a speech synthesiser and replayed to the user by means of a loudspeaker, headphones, etc. Preferably, the user may view the audio content on a display unit after the audio content has been rendered into text form, so that the text representation can be displayed on a display unit such as a personal computer screen, a mobile telephone display, a TV screen, etc. The user may indicate changes to the text representation verbally, for example, by speaking editing commands into a microphone. The spoken editing commands may subsequently be converted into the corresponding editing commands by a suitable speech interpretation unit. Alternatively, changes may be made in the text representation by typing them by means of, for instance, a keyboard or a keypad. The speech interpretation unit and/or display unit is preferably connected in some way to the editor, so that the user can observe the text of the text representation while editing. The phonetic elements of the audio content are subsequently modified in the audio alteration unit in accordance with the changes in the text representation.

The modified audio content is preferably replayed to the user before presenting the message, by means of a suitable audio output, for example, a loudspeaker or headphones. The user can listen to the modified audio content and decide whether it is satisfactory, or if further changes in the text representation need to be made before finally sending the message.

The editor for editing the text representation may be incorporated in the personal computer, mobile phone, home entertainment device, etc. using the display unit of this device. The user may make changes in the text of the text representation by re-arranging, deleting or copying elements of the text representation. These changes are then made in a corresponding manner in the phonetic elements of the audio content. For example, if a text element has been deleted from the text representation, the corresponding phonetic element, identified by means of its time marker, will also be deleted. If a text element has been moved to a different position in the text representation, the corresponding phonetic element will be removed from its original position in the audio content and inserted into a different position corresponding to the change in the text representation.

The user may even insert a new word or words not already existing in the text representation. In this case, the new word is identified in an appropriate manner by the editor. The audio alteration unit can check if it already has this word in a library or database of words, or, if the constituent phonemes of the word are already present in the audio content, the audio alteration unit may assemble the word by putting together the constituent phonemes in the correct order.

In addition to merely removing or rearranging text elements in the text representation, the user may insert mark-ups into the text to indicate a certain type of change to be made in the corresponding phonetic elements. For example, special characters such as exclamation marks might be inserted before and after a word, indicating that this word is to be made louder in the audio content. Alternatively, the user may change the typeface of a word, so that, for example, a word or words changed in the text representation to italic typeface is made quieter in the audio content. Other types of changes may comprise changing the voice quality of the speaker, for example, changing the speaker's voice from male to female or vice versa, or applying different speaker characteristics to the voice. These mark-ups may then be encoded as commands or comments in the text representation in a form suitable for interpretation by the audio alteration unit.

The audio alteration unit interprets the changes in the text representation and makes the required changes in the relevant phonetic elements. The phonetic elements can be altered, for example, to make a word louder or quieter or to otherwise change the emphasis on the word. This can be achieved by altering the appropriate characteristics of the phonetic elements, e.g. the pitch, by applying a suitable filter or function to the phonetic element.

All of these alterations can be made by means of applying known audio processing techniques, which may be incorporated in a computer program or stored in a collection or database of audio processing functions or algorithms. The mark-ups in the modified text representation may be used to automatically retrieve or activate the appropriate algorithm or function.

In a preferred embodiment of the invention, the user can specify the granularity of the segmentation, for example, by entering an appropriate command to the system. A coarse granularity may suffice for messages to be exchanged in a chat group, where the audio quality does not need to have a very high level. In other applications, such as preparing a report, a speech or an announcement to be delivered in high-quality audio, a fine granularity can be specified to allow detailed corrections to be carried out in the audio content. A higher value of granularity will give a better audio processing quality, with an associated higher effort.

In a particularly preferred embodiment of the invention, audio smoothing techniques are applied to the altered audio content so as to ensure smooth transitions between adjacent phonetic elements, because alteration of the phonetic elements of the audio content by re-arranging them or changing their characteristics might result in an uneven or jagged sounding audio content.

The invention also allows processing of messages comprising video content, in which case the method of modifying an input message also comprises segmenting the video content of the message into corresponding frame segments, or sequences of frames, correlating to the text representation, and altering the correlating frame segments of the video content in accordance with the edited text representation or the altered phonetic elements of the audio content, as appropriate, so as to give a modified video content of an output message.

A frame segment is understood to be a number of consecutive frames associated with a corresponding text element. In a manner similar to that already described, values marking elapsed time in chronological order are also assigned to the frame sequences during the video segmentation process in such a way that a frame sequence can be located or identified on the basis of its time values. A frame sequence may be matched with its corresponding text representation element or, equally, to the corresponding audio segment. In this way, a correlation or equivalence is easily established between the frame sequences of the video content and the text representation elements and/or the audio segments. The length of a frame sequence may also be determined by the granularity of the segmentation process.

The edits carried out in the text representation are reflected in the video content by carrying out the appropriate alteration. If the user has deleted or re-arranged some elements of the text representation, the corresponding video frame sequences are located with the aid of the time values and are deleted or re-arranged as required. Certain mark-ups inserted into the text representation may have no effect on the video content; for example, a change in the vocal characteristics of the speaker's voice will not necessarily require any modification of the video content. However, some types of mark-up may be interpreted to alter the video content so as to introduce special effects such as strobes, flashing or inverse colour. For example, if a word or a number of words in the text representation has been marked in some way, such as by underlining or enclosing it between exclamation marks, the corresponding phonetic elements may be made louder and the corresponding video frame sequences may be modified to include a flashing or strobe effect.

An appropriate system for modifying an input message containing video content comprises a video input, such as a web cam, a mobile phone with integrated camera, a video camera, etc., for recording video content of the input message. The video content of the message is broken down or segmented in a video segmentation unit into frame segments correlating to elements of the text representation, and altered in a video alteration unit in accordance with modifications of the text representation so as to give a modified video content of an output message. Audio and video contents of the message are then re-combined in an audio/video re-combining unit so as to give an output message.

A video output such as a display or TV screen can preferably be used for replaying the modified video content of the output message.

In a particularly preferred embodiment of the invention, video smoothing techniques such as filtering or morphing are applied to the modified video content so as to give smooth transitions between consecutive frame segments in the modified video content.

The method can be applied to the generation and editing of any kind of message where improvements of the original are often required, such as a message on an answering machine, messages for relaying on a public-address system, audio-visual announcements, etc. The method described is particularly advantageous in messaging systems for sending messages such as for audio-visual chat groups, as mentioned hereinbefore, via the Internet or over a telecommunication network.

An appropriate method of assembling and sending a message comprises capturing audio and, optionally, video contents of an input message, altering the audio and/or video contents of the input message by using a method as described above so as to give an output message, replaying the output message to a user for confirmation of correctness, and sending the output message after the user has confirmed its correctness.

A messaging system for assembling and sending a message according to this method therefore comprises an audio input for recording audio content of the input message and, optionally, a video input for recording video content of the input message, an alteration unit for altering the audio and optional video contents of the input message by using a method as described above so as to give a modified output message, an audio output and an optional video output for replaying the modified content of the output message to a user for confirmation of correctness, and a sending unit for sending the output message after the user has confirmed its correctness.

A preferred feature of the invention comprises a computer program product for performing all the steps involved in altering an input message, i.e. most or all of the components of the system for modifying messages (message modifying system) such as speech-to-text converter, audio segmentation, video segmentation, audio alteration, video alteration, recombining, etc. are realized in the form of software and/or hardware modules. Any required software may be encoded on a processor of the message modifying system, or encoded on a separate processor, so that an existing message modifying system may be adapted to benefit from the features of the invention. The message modifying system could be connected to, or be part of, any system or device, which serves to assemble or process messages, e.g. a messaging system, an answering machine, etc.

Other objects and features of the invention will become apparent from the following detailed descriptions considered in conjunction with the accompanying drawings. However, it is to be understood that the drawings are designed solely for the purpose of illustration and not as a definition of the limits of the invention.

### BRIEF DESCRIPTION OF THE DRAWINGS

FIG. 1 is a block diagram of a system for modifying an input message in accordance with an embodiment of the invention.

FIGS. 2a to 2d are graphical representations of recorded sound waves and frame segments of a message in accordance with an embodiment of the invention.

### DESCRIPTION OF EMBODIMENTS

In the description of the following Figures, which do not exclude other possible realizations of the invention, the system for modifying an input message is shown as part of a messaging system which can be incorporated in any suitable audio-visual device, for example, a home entertainment system, PC, TV, mobile telephone, multimedia device, etc., which comprises an appropriate interface to any suitable communication network. The system includes a user interface 14 for interpreting commands issued by a user, comprising a keyboard 22 or keypad, a mouse 23, a screen 8, and a loudspeaker 20. The graphical representations of sound waves and frame segments are not intended as exact renditions, and only serve illustrative purposes.

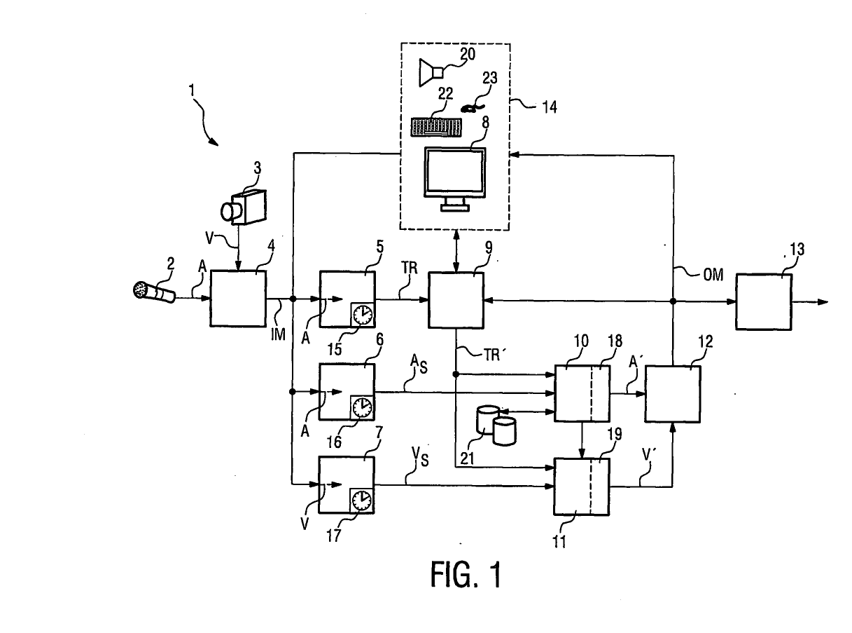

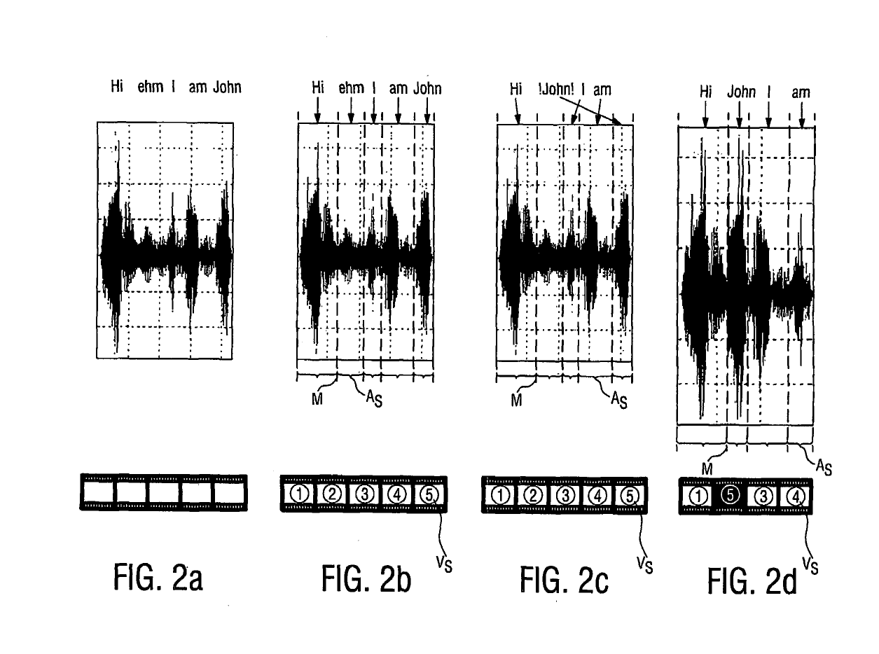

In the messaging system 1 depicted in FIG. 1, a user (not shown in the diagram) is filmed by a video camera 3 while speaking a message, e.g. “Hi, ehm, I am John” into a microphone 2. The video camera 3 and the microphone 2 pass the video content V and audio content A, respectively, to a capture unit 4 in which any necessary processing is performed to record and incorporate the audio content A and video content V into an input message IM in a digital form, such as MPEG2 or MPEG4. The sound waveform corresponding to the audio content A, along with a series of frame sequences corresponding to the video content V, is shown graphically in a simplified form in FIG. 2a.

The digitized input message IM is forwarded to a converter unit 5, to an audio segmenting unit 6 and to a video segmenting unit 7, each of which extracts the relevant input stream, A or V, respectively. All of the three blocks 5, 6, 7 contain synchronization blocks 15, 16, 17 that are connected in a usual manner, not shown in the diagram. Each synchronization block 15, 16, 17 is capable of measuring time by means of, for example, a digital clock or counter. In this embodiment, the capture unit 4 marks the start of the message IM by means of an appropriate null marker or starting time, with reference to which the synchronization blocks 15, 16, 17 measure the passage of time. Furthermore, the synchronization block 15 of the converter 5 is capable of sending appropriate signals to the other synchronization blocks 16, 17.

In the converter 5, speech recognition algorithms are applied to the audio content of the input message IM to obtain the text representation TR. This block is therefore referred to hereinafter as a speech-processing unit. The text representation TR is encoded in a form such as ASCII, and segmented into its constituent text elements. The size or complexity of the elements, i.e. groups of words, individual words, syllables or phonemes, being specified by the user by means of appropriate input via the user interface. Each text element is marked with a value of time measured with respect to the starting time, so that each text element is thus uniquely defined by its chronological position in the text representation TR. The act of marking a text element is an event, which is reported by the synchronization block 15 of the speech-processing unit 5 to the synchronization blocks 16, 17 of the audio segmenting unit 6 and the video segmenting unit 7, respectively.

The audio segmenting unit 6 reacts to the reported events by placing markers M at the appropriate position in the audio content A so as to give a segmented audio content consisting of phonetic elements A_{S}, shown graphically in FIG. 2b. In this way, each text element of the input message IM, identified in the speech-processing unit 5, can be matched with a phoneme A_{S} or sound element A_{S} in the segmented audio content of the input message IM. Similarly, the video segmenting unit 7, in response to the event reported to its synchronization block 17 by the synchronization block 15 of the speech-processing unit 5, places markers in the video content V so as to give a segmented video content consisting of frame segments V_{S}, also shown in FIG. 2b, allowing text elements of the text representation or segments of the audio content A_{S} to be matched with the corresponding frame sequences V_{S} in the segmented video content.

The messaging system 1 enables the user to change the message before it is sent. To this end, the text representation TR is displayed in a form suitable for editing by an editor 9. In this example, the user can view the text “Hi ehm I am John” of the message IM on a display unit 8, such as the screen of a personal computer, and he can edit the text representation TR so as to obtain the desired changes. In this example, the user deletes the “ehm”, rearranges the words, and changes the emphasis on the word “John” by enclosing it between exclamation marks, thus yielding “Hi! John! I am”. This editing input is encoded by the editor 9 in the text representation, perhaps in the form of commands or comments, so that the special characters such as the exclamation marks are inserted in the text representation TR at the appropriate positions, and the elements of the text representation TR are rearranged or changed in accordance with the changes made by the user.

The modified text representation TR′ is passed to an audio alteration block 10, where the changes are interpreted and any necessary rearrangement of the phonetic elements A_{S} of the segmented audio content is calculated, shown graphically in FIG. 2c. For example, where an element has been removed from the text representation, such as the “ehm” in this example, the corresponding phonetic elements, located with the aid of the time values and any command or comment encoded in the modified text representation TR′, are removed from the segmented audio content A_{S}. The phonetic element corresponding to an element which has been moved from its original position to a new position, such as the “John” in this example, can be moved from its original position in the segmented audio content A_{S} and inserted at the appropriate position. The special characters surrounding the element “John”, in this case exclamation marks are interpreted to imply that the volume of the corresponding phonetic element is to be increased. This is achieved, for example, by applying an appropriate filter or amplifier to this audio segment.

The modified signal of the audio content is shown in FIG. 2d. The audio segments, when rearranged to correspond to the modified text representation TR′, may now feature jagged transitions or artifacts that arise due to the modification process. To ensure that the modified audio content A′ is comfortable to listen to, audio smoothing techniques are applied as necessary to the rearranged audio segments in an audio smoothing unit 18.

In a video alteration block 11, the changes in the modified text representation TR′ are transferred to the segmented video content in a manner analog to the audio alteration—where an element has been removed from the text representation, such as the “ehm” in this example, the corresponding video frame sequences V_{S}, located with the aid of its time values and any command or comment encoded in the modified text representation TR′, are removed from the segmented video content V_{S}. The video frame sequence corresponding to an element which has been moved from its original position to a new position, such as the “John” in this example, can be moved from its original position in the segmented video content V_{S} and inserted again at the appropriate position. The results of rearranging the video frame sequences are also shown graphically in FIG. 2d. Changing the loudness of the element “John” may be accompanied by a special video effect such as a strobe effect or flashing. If this is desired, the video alteration introduces the special effects for the duration of the corresponding frame sequence in the segmented video content V_{S}. The video frame sequences, when rearranged or otherwise altered to correspond to the modified text representation TR′, may now feature abrupt and unnatural transitions. To counteract this effect, video smoothing techniques can be applied as necessary to the video frame sequences in a video smoothing block 19, so as to give a modified video content V′.

The video alteration unit may preferably also be equipped with suitable algorithms and processing techniques to change the facial expression of the person in the video content in accordance with changes in the text representation. In this way, mark-ups indicating facial expressions, such as, for example, <smile> or <frown> might result in the face of the speaker being altered to make it smile or look annoyed, depending on the mark-up.

In a recombining block 12, the modified audio and video contents A′, V′ are recombined so as to give an output message OM. To enable the user to view the modified message, it is presented visually by displaying the video content on the screen 8, and audibly by playing the audio content on a loudspeaker 20 of the user interface 14. Simultaneously, the corresponding text being displayed by the editor 9 so that, if desired, the user can make any further changes in the text of the output message OM.

For example, he may wish to insert a new word into the text, so that the message reads “Hi John I am done”. In the case of such a modification, where a new element—unaccompanied by a matching phonetic element—is introduced into the text representation, the audio alteration unit 10 can retrieve a suitable phonetic element from a database 21. Such a database 21 may be assembled over time with samples of phonetic elements copied from previous messages. Alternatively, the speech-processing unit may feature a speech synthesiser for generating speech signals from text. In the case of the video content, the video alteration unit 11 may simply duplicate suitable frames of the video content and morph these into the existing video frame sequences V_{S}. Again, the outputs of the audio alteration unit 10 and the video alteration unit 11 are recombined in the recombining unit 12 and presented once more to the user for confirmation.

Once the user confirms that the output message OM is satisfactory, the message OM is sent to its destination by a sending unit 13. This unit may be, for example, a video-chat application or an email application.

Although the invention has been disclosed in the form of preferred embodiments and variations thereof, it will be understood that numerous additional modifications and variations could be made without departing from the scope of the invention. For example, the database or the algorithms applied by the audio/video alteration units can be updated or replaced as desired by downloading new information or algorithms from the Internet. In this way, the messaging system can make use of the most current audio and video processing techniques.

The messaging system may make use of developments in avatar simulation techniques to provide a video accompanying an audio message, without having to actually film him speaking. The avatar may resemble the user or have a different appearance, and may appear in front of a particular background, or the user may supply a background picture by means of a picture taken by a camera or an image downloaded from an external source. For the sake of clarity, it is to be understood that the use of the indefinite article “a” or “an” throughout this application does not exclude a plurality of steps or elements, and the use of the verb “comprise” and its conjugations does not exclude other steps or elements. The use of the word “unit” or “module” does not limit realization to a single unit or module.

1. A method of modifying an input message (IM) containing audio content, which method comprises the steps of:
converting the audio content (A) of the input message (IM) into elements of a text representation (TR);
segmenting the audio content (A) of the input message (IM) into constituent phonetic elements (Aₛ) correlating to the text representation (TR);
rendering the text representation (TR) into a form suitable for editing;
modifying the text representation (TR) in accordance with editing input; and
altering the correlating phonetic elements (Aₛ) of the audio content (A) in accordance with the edited text representation (TR′) so as to give a modified audio content (A′) of an output message (OM).

2. A method as claimed in claim 1, wherein editing the text representation (TR) comprises insertion, duplication, deletion or re-arrangement of elements in the text representation (TR) so as to give the modified text representation (TR′).

3. A method as claimed in claim 2, wherein alteration of the phonetic elements (Aₛ) of the audio content (A) comprises duplication, deletion or re-arrangement of segments of the audio content (A) and/or insertion of phonetic elements into the audio content.

4. A method as claimed in claim 1, wherein editing the text representation (TR) comprises insertion of mark-ups at specific positions in the text representation (TR) so as to give the modified text representation (TR′).

5. A method as claimed in claim 1, wherein alteration of the phonetic elements (A_{S}) of the audio content (A) comprises alteration of characteristics of the phonetic elements (A_{S}).

6. A method as claimed in claim 1, wherein audio smoothing techniques are applied to the altered audio content (A′) so as to give smooth transitions between adjacent phonetic elements.

7. A method as claimed in claim 1, wherein the input message (IM) contains a corresponding video content (V), and the method comprises the steps of:
segmenting the video content (V) of the input message (IM) into corresponding frame segments (V_{S}) correlating to the text representation (TR); and
altering the correlating frame segments (V_{S}) of the video content (V) in accordance with the edited text representation (TR′) or the altered phonetic elements (A′) of the audio content (A) so as to give a modified video content (V′) of an output message (OM).

8. A method as claimed in claim 7, wherein video smoothing techniques are applied to the modified video content (V′) so as to give smooth transitions between consecutive frame segments in the modified video content (V′).

9. A method of assembling and sending a message, which method comprises the steps of:
capturing audio and optional video contents (A, V) of an input message (IM);
altering the audio and optional video contents (A, V) of the input message (IM) by using a method as claimed in any one of claims 1 to 8 so as to give an output message (OM);
replaying the output message (OM) to a user for confirmation of correctness; and
sending the output message (OM) after the user has confirmed its correctness.

10. A system (1) for modifying an input message (IM), comprising
an audio input (2) for recording audio content (A) of the input message (IM);
a converter (5) for converting the audio content (A) of the input message (IM) into elements of a text representation (TR);
an audio segmenting unit (6) for segmenting the audio content (A) of the input message (IM) into constituent phonetic elements (Aₛ) correlating to the text representation (TR);
a rendering unit (8) for rendering the text representation (TR) into a form suitable for editing;
an editor (9) for allowing editing of the text representation (TR); and
an audio alteration unit (10) for altering the correlating phonetic elements (A_{S}) in accordance with the edited text representation (TR′) so as to give a modified audio content (A′) of an output message (OM).

11. A system as claimed in claim 10, comprising a video input (3) for recording video content (V) of the input message (IM);
a video segmentation unit (7) for segmenting the video content (V) of the input message (IM) into corresponding frame segments (V_{S}) correlating to the text representation (TR);
a video alteration unit (11) for altering the correlating frame segments (V_{S}) of the video content (V) in accordance with the modified text representation (TR′) or the altered phonetic elements (A′) of the audio content (A) so as to give a modified video content (V′) of an output message (OM); and
an audio/video re-combining unit (12) for re-combining the audio and video (A′, V′) contents so as to give an output message (OM).

12. A messaging system (1) for assembling and sending a message, comprising
an audio input (2) for recording audio content (A) of the input message (IM) and, optionally, a video input (3) for recording video content (V) of the input message (IM);
an alteration unit (10, 11) for altering the audio and optional video (A, V) contents of the input message (IM) by using a method as claimed in claim 1 so as to give a modified output message (OM′);
an audio output (20) and, optionally, a video output (8) for replaying the modified content (A′, V′) of the output message (OM) to a user for confirmation of correctness; and
a sending unit (13) for sending the output message (OM) after the user has confirmed its correctness.

13. A computer program product directly loadable into the memory of a programmable message modifying system (1) comprising software code portions for performing the steps of the method as claimed in claim 1, when said product is run on the message modifying system (1).
